(19) United States
(12) Patent Application Publication
(10) Pub. No.: US 2015/0075989 A1
(43) Pub. Date: Mar. 19, 2015

(54) DEVICES AND METHODS USING POROUS MEMBRANES FOR OIL-WATER EMULSION SEPARATION

(71) Applicant: Massachusetts Institute of Technology, Cambridge, MA (US)

(72) Inventors: Brian Richmond Solomon, Rockville, MD (US); Kripa K. Varanasi, Lexington, MA (US); Md Nasim Hyder, Somerville, MA (US)

(73) Assignee: Massachusetts Institute of Technology, Cambridge, MA (US)

(21) Appl. No.: 14/212,690

(22) Filed: Mar. 14, 2014

Related U.S. Application Data
(60) Provisional application No. 61/798,774, filed on Mar. 15, 2013.

(51) Int. Cl. C02F 1/44; C02F 1/469; B01D 69/02

(52) U.S. Cl. CPC C02F 1/44; B01D 69/02; C02F 1/4696; B01D 2325/16; B01D 2325/26; B01D 2325/36; B01D 2325/38; C02F 2101/32
USPC 204/514; 210/650; 210/641; 210/321.64

(57) ABSTRACT

The invention provides methods and devices that use membranes to separate oil/water mixtures. The methods and devices have a wide range of applications, including deep seep oil exploration, oil purification, and oil spill cleanup. In some embodiments, at least one first membrane is provided, the first membrane being hydrophilic and oleophobic. The first membrane allows passage of water therethrough In some embodiments, a second membrane that is hydrophobic and oleophilic is provided in addition to the first membrane. The second membrane allows passage of oil therethrough.

### CROSS REFERENCE TO RELATED APPLICATIONS

This application claims priority to and the benefit of, and incorporates herein by reference in its entirety, U.S. Provisional Patent Application No. 61/798,774, which was filed on Mar. 15, 2013 and titled “Devices and Methods Using Porous Membranes for Oil-Water Emulsion Separation.”

### FIELD OF INVENTION

This invention relates generally to articles, devices, and methods for oil-water separation, and, in particular, in some embodiments, to articles, devices, and methods using one or more porous membranes for oil-water separation.

### BACKGROUND OF THE INVENTION

Separation of oil and water mixtures (oil-water emulsions) is of great importance across a wide range of technologies and industries. For example, oil and water separation problems gained national attention during the 2010 Gulf oil spill and subsequent cleanup efforts. The petroleum industry faces similar water and oil separation challenges as it attempts to extract oil from beneath the sea.

Existing separation devices and methods are either environmentally unfriendly, extremely energy intensive, or incapable of performing the desired separations (or a combination of these). For example, in deep-sea oil extraction, one energy-intensive conventional approach is to pump oil-water emulsions (or oil and water mixtures) from the ocean floor to the surface where the emulsions are stored in gravity separation tanks. In addition, once much of the water has been removed from the oil, existing techniques (e.g., ultracentrifugation) are incapable of removing additional, trace amounts of water that remain. These trace amounts of water in oil may cause significant problems for end users, process equipment, and machinery. In addition, conventional techniques are incapable of removing trace amounts of oil from water—which is a significant environmental concern. Current separation techniques are therefore inefficient and incapable of performing the wide range of oil and water separations of interest.

In recent years, growing environmental concerns have fueled the need for efficient separation of oil-water mixtures. Oil spills, as highlighted by the Deepwater Horizon spills, have lasting detrimental ecological effects. The threat is recurring and persistent; every year over 20,000 oil spills are reported to the U.S. government. Aside from such disasters, fats, oils, and grease are classified as hazardous waste and their removal (e.g., from water before the water being released into the environment) is subject to increasingly more stringent governmental regulation. Generally, according to U.S. regulations, water needs to be cleaned to about 10 ppm of oil or less prior to being discharged.

In addition, separation of nanoemulsions (i.e., oil-water mixtures including sub-micron droplets) remains a key challenge that has not been met by conventional systems.

There is a need for more efficient and more environmentally-friendly devices and methods for separating oil-water emulsions (and oil and water mixtures). In particular, a need exists for separating trace amounts of water from oil-water emulsions and for separating trace amounts of oil from oil-water emulsions.

### SUMMARY OF THE INVENTION

Various embodiments of the invention relate to devices and methods useful for separating oil-water emulsions (or oil and water mixtures) using one or more porous membranes. In principle, the membranes may be applied to the separation of two immiscible liquids—e.g., oil and water. Unlike existing separation techniques, the membranes and methods described herein may be used to separate trace amounts of water (e.g., no greater than 3 wt % water content, no greater than 1 wt % water content, or 50-1000 ppm water) from oil. By altering various properties of the membrane (such as pore size, hydrophobicity, oleophobicity, and/or layer thickness), parameters critical to operation can be precisely controlled, such as the breakthrough pressure and permeability. The membrane has a wide range of applications, including deep seep oil recovery, oil purification, and oil spill cleanup.

In some embodiments, membranes that are able to switch between oleophobicity and hydrophilicity and/or membranes that are able to switch between oleophilicity and hydrophobicity depending on the nature of the contacting medium, are used.

In some embodiments, a membrane that is either hydrophilic and oleophobic or hydrophobic and oleophilic depending on a polarity of a contacting medium is used for oil-water separations.

Some embodiments of the invention relate to separation of nanoemulsions, with which separation of oil-water emulsions with droplet size smaller than 1 μm may be achieved. Designing effective membranes requires optimization of a number of different parameters—tradeoffs between geometric constraints, high breakthrough pressure for selectivity, high flux, and mechanical durability make it especially challenging.

In one aspect, the invention provides a method for performing an oil/water separation, the method including: providing a membrane that is either hydrophilic and oleophobic or hydrophobic and oleophilic depending on a polarity of a contacting medium; passing a first liquid stream or volume including oil and water, and having a first water to oil ratio, wherein the first ratio is greater than 1; contacting the first liquid stream or volume with the membrane, wherein the membrane is hydrophilic and oleophobic during contact with the first stream or volume and allows passage of water therethrough; and contacting a second liquid stream or volume with the membrane, wherein the second liquid stream or volume has a second water to oil ratio less than 1, and wherein the membrane is hydrophobic and oleophilic during contact with the second stream or volume, and does not allow passage of water therethrough. In some embodiments, the first stream or volume is an initial condition of the stream or volume and the second stream or volume is a following condition of the same stream or volume.

In some embodiments, the first stream or volume is an initial condition of the stream or volume and the second stream or volume is a following condition of the same stream or volume.

In some embodiments, the membrane includes a polymer. In some embodiments, the polymer is a polyurethane.

In some embodiments, the polyurethane includes a perfluoropolyether (PFPE) segment, a polydimethylsiloxane (PDMS) segment, a polyethylene glycol (PEG) segment, or any combination thereof. In some embodiments, the polyurethane includes a perfluoropolyether (PFPE) segment. In some embodiments, the polyurethane includes polydimethylsiloxane (PDMS) segment. In some embodiments, the polyurethane includes a polyethylene glycol (PEG) segment.

In one aspect, the invention provides a method for performing an oil/water separation, the method including: providing a first membrane that is hydrophilic and oleophobic; contacting a first liquid stream or volume including oil and water with the first membrane, wherein the first membrane allows passage of water therethrough to produce a second liquid stream or volume; and applying a voltage between a portion of the first membrane and the first liquid stream thereby enhancing the hydrophilicity of the portion of the first membrane.

In some embodiments, the method further includes providing a second membrane that is hydrophobic and oleophilic; and contacting the first liquid stream or volume comprising oil and water with the second membrane, wherein the second membrane allows passage of oil therethrough. In some embodiments, the method further includes providing a second membrane that is hydrophobic and oleophilic; and contacting the second liquid stream or volume with the second membrane, wherein the second membrane allows passage of oil therethrough.

In one aspect, the invention provides a method for performing an oil/water separation, the method including: providing a second membrane that is hydrophobic and oleophilic; contacting a first liquid stream or volume including oil and water with the first membrane, wherein the second membrane allows passage of oil therethrough to produce a second liquid stream or volume; applying a voltage between a portion of the first membrane and the first liquid stream thereby enhancing the hydrophilicity of the portion of the first membrane; providing a first membrane that is hydrophilic and oleophobic; and contacting the second liquid stream or volume with the second membrane, wherein the first membrane allows passage of water therethrough.

In some embodiments, the second membrane includes a polymer selected from the group consisting of polysulfone (PSF), poly(vinylpyrrolidone) (PVP), polyacrylonitrile (PAN), polycarbonate, polyethersulfone (PES), and any combination thereof. In some embodiments, the second membrane includes polysulfone (PSF). In some embodiments, the second membrane includes poly(vinylpyrrolidone) (PVP). In some embodiments, the second membrane includes polyacrylonitrile (PAN). In some embodiments, the second membrane includes polycarbonate. In some embodiments, the second membrane includes polyethersulfone (PES).

In some embodiments, the second membrane includes a first layer and a second layer, wherein the second layer is a support layer that is substantially thicker than the first layer and has a substantially larger average pore size than the first layer. In some embodiments, the first layer has a thickness from about 0.3 micron to about 2 microns. In some embodiments, the first layer has a thickness from about 0.5 micron to about 2 microns. In some embodiments, the first layer has an average pore size from about 25 nm to about 300 nm.

In some embodiments, the first layer has an average pore size from about 50 nm to about 200 nm. In some embodiments, the first layer has an average pore size from about 100 nm to about 150 nm. In some embodiments, the support layer has a thickness from about 55 microns to about 370 microns. In some embodiments, the support layer has an average pore size from about 10 microns to about 25 microns.

In some embodiments, the first layer includes a coating. In some embodiments, the coating is a silane coating. In some embodiments, the silane coating includes at least one member selected from the group consisting of octadecyltrichlorosilane (OTS), methylsilane, phenylsilane, isobutylsilane, dimethylsilane, tetramethyldisilane, hexylsilane, octadecylsilane, fluorosilane, or any combination thereof.

In some embodiments, the second membrane includes polycarbonate and the second membrane has a coating including octadecyltrichlorosilane (OTS).

In one aspect, the invention provides a device for performing an oil/water separation, the device including a channel, wherein the channel includes a first opening with a first membrane that is hydrophilic and oleophobic and a second opening with a second membrane that is hydrophobic and oleophilic, wherein the first and second membranes are configured so that when a liquid stream or volume including oil and water is introduced into the channel it contacts the first and second membranes, wherein the first membrane allows passage of water therethrough and the second membrane allows passage of oil therethrough.

In some embodiments, the first membrane is configured across the width of the channel and the second membrane is configured across an opening in a wall of the channel. In some embodiments, the second membrane is configured across the width of the channel and the first membrane is configured across an opening in a wall of the channel.

In some embodiments, the device includes a plurality of first membranes that are configured across the width of the channel. In some embodiments, the plurality of first membranes includes at least two first membranes with different average pore sizes. In some embodiments, the average pore size of the plurality of first membranes gets progressively smaller as one travels downstream along the channel. In some embodiments, the plurality of first membranes are spaced apart and each separated by one or more openings in a wall of the channel. In some embodiments, the first membrane includes interconnected pores. In some embodiments, the first membrane has an open-cell structure.

In some embodiments, a plurality of second membranes are configured across the one or more openings in the wall of the channel. In some embodiments, the plurality of second membranes includes at least two second membranes with different average pore sizes. In some embodiments, the average pore size of the plurality of second membranes gets progressively smaller as one travels downstream along the channel.

In some embodiments, the device includes a plurality of second membranes that are configured across the width of the channel. In some embodiments, the plurality of second membranes includes at least two second membranes with different average pore sizes. In some embodiments, the average pore size of the plurality of second membranes gets progressively smaller as one travels downstream along the channel.

In some embodiments, the plurality of second membranes are spaced apart and each separated by one or more openings in a wall of the channel. In some embodiments, a plurality of first membranes are configured across the one or more openings in the wall of the channel. In some embodiments, the plurality of first membranes includes at least two first membranes with different average pore sizes. In some embodiments, the average pore size of the plurality of first membranes gets progressively smaller as one travels downstream along the channel.

In some embodiments, the first membrane includes cationic fluorosurfactants complexed to a polymer surface. In some embodiments, the first membrane includes cationic fluorosurfactants complexed to a maleic anhydride plasma polymer surface. In some embodiments, the first membrane includes cationic fluorosurfactants complexed to an acrylic acid plasma polymer surface.

In some embodiments, the device also includes one or more electrical elements configured to apply a voltage between a portion of the first membrane and a liquid stream in the channel, thereby enhancing the hydrophilicity of the portion of the first membrane.

In some embodiments, the second membrane includes a polymer selected from the group consisting of polysulfone (PSF), poly(vinylpyrrolidone) (PVP), polyacrylonitrile (PAN), polycarbonate, polyethersulfone (PES), and/or any combination thereof. In some embodiments, the second membrane includes polysulfone (PSF). In some embodiments, the second membrane includes poly(vinylpyrrolidone) (PVP). In some embodiments, the second membrane includes polyacrylonitrile (PAN). In some embodiments, the second membrane includes polycarbonate. In some embodiments, the second membrane includes polyethersulfone (PES).

In some embodiments, the second membrane includes a first layer and a second layer, wherein the second layer is a support layer that is substantially thicker than the first layer and has a substantially larger average pore size than the first layer. In some embodiments, the first layer has a thickness from about 0.3 micron to about 2 microns. In some embodiments, the first layer has a thickness from about 0.5 micron to about 2 microns. In some embodiments, the first layer has an average pore size from about 25 nm to about 300 nm. In some embodiments, the first layer has an average pore size from about 50 nm to about 200 nm. In some embodiments, the first layer has an average pore size from about 100 nm to about 150 nm. In some embodiments, the support layer has a thickness from about 55 microns to about 370 microns. In some embodiments, the support layer has an average pore size from about 10 microns to about 25 microns.

In some embodiments, the first layer includes a coating. In some embodiments, the coating is a silane coating. In some embodiments, the silane coating comprises at least one member selected from the group consisting of octadecyltrichlorosilane (OTS), methylsilane, phenylsilane, isobutylsilane, dimethylsilane, tetramethyldisilane, hexylsilane, octadecylsilane, fluorosilane, and/or any combination thereof. In some embodiments, the second membrane includes polycarbonate and the second membrane has a coating including octadecyltrichlorosilane (OTS).

In one aspect, the invention provides a method for performing an oil/water separation, the method including: providing a first membrane that is hydrophilic and oleophobic; and contacting a first liquid stream or volume including oil and water with the first membrane, wherein the first membrane allows passage of water therethrough to produce a second liquid stream or volume.

In some embodiments, the method further includes providing a second membrane that is hydrophobic and oleophilic; and contacting the first liquid stream or volume including oil and water with the second membrane, wherein the second membrane allows passage of oil therethrough.

In some embodiments, the method further includes providing a second membrane that is hydrophobic and oleophilic; and contacting the second liquid stream or volume with the second membrane, wherein the second membrane allows passage of oil therethrough.

In one aspect, the invention provides a method for performing an oil/water separation, the method including: providing a second membrane that is hydrophobic and oleophilic; contacting a first liquid stream or volume including oil and water with a first membrane, wherein the second membrane allows passage of oil therethrough to produce a second liquid stream or volume; providing the first membrane that is hydrophilic and oleophobic; and contacting the second liquid stream or volume with the second membrane, wherein the first membrane allows passage of water therethrough.

In some embodiments, the first membrane includes cationic fluorosurfactants complexed to a polymer surface. In some embodiments, the first membrane includes cationic fluorosurfactants complexed to a maleic anhydride plasma polymer surface. In some embodiments, the first membrane includes cationic fluorosurfactants complexed to an acrylic acid plasma polymer surface.

In some embodiments, the second membrane includes a polymer selected from the group consisting of polysulfone (PSF), poly(vinylpyrrolidone) (PVP), polyacrylonitrile (PAN), polycarbonate, polyethersulfone (PES), and any combination thereof. In some embodiments, the second membrane includes polysulfone (PSF). In some embodiments, the second membrane includes poly(vinylpyrrolidone) (PVP). In some embodiments, the second membrane includes polyacrylonitrile (PAN). In some embodiments, the second membrane includes polycarbonate. In some embodiments, the second membrane includes polyethersulfone (PES).

In some embodiments, the second membrane includes a first layer and a second layer, wherein the second layer is a support layer that is substantially thicker than the first layer and has a substantially larger average pore size than the first layer. In some embodiments, the first layer has a thickness from about 0.3 micron to about 2 microns. In some embodiments, the first layer has a thickness from about 0.5 micron to about 2 microns. In some embodiments, the first layer has an average pore size from about 25 nm to about 300 nm. In some embodiments, the first layer has an average pore size from about 50 nm to about 200 nm. In some embodiments, the first layer has an average pore size from about 100 nm to about 150 nm. In some embodiments, the support layer has a thickness from about 55 microns to about 370 microns. In some embodiments, the support layer has an average pore size from about 10 microns to about 25 microns.

In some embodiments, the first layer includes a coating. In some embodiments, the coating is a silane coating. In some embodiments, the silane coating includes at least one member selected from the group consisting of octadecyltrichlorosilane (OTS), methylsilane, phenylsilane, isobutylsilane, dimethylsilane, tetramethyldisilane, hexylsilane, octadecylsilane, and fluorosilane.

In some embodiments, the second membrane includes polycarbonate and the second membrane has a coating comprising octadecyltrichlorosilane (OTS).

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a photograph of an oil film on a membrane surface, in accordance with an illustrative embodiment of the invention.

FIG. 2 is a schematic cross-sectional view of a membrane, in accordance with an illustrative embodiment of the invention.

FIG. 3A is a SEM image of a top surface of a membrane, in accordance with an illustrative embodiment of the invention.

FIG. 3B is a SEM image of a cross-section of a membrane, in accordance with an illustrative embodiment of the invention.

FIG. 4 includes a schematic front view of a plasma etching process, in accordance with an illustrative embodiment of the invention.

FIG. 5 includes photographs of a dry membrane and a membrane wetted by oil, in accordance with an illustrative embodiment of the invention.

FIG. 6 includes a schematic diagram and a photograph of a device for performing oil and water separation experiments.

FIG. 7 includes a schematic illustration and a series of photographs of a coated polycarbonate membrane, in accordance with an illustrative embodiment of the invention.

FIGS. 8A-8D include SEM images and photographs of a coated polycarbonate membrane, in accordance with an illustrative embodiment of the invention.

FIGS. 9A-9B include a macroscopic photo and a microscopic photo demonstrating filtration of emulsions through coated polycarbonate membranes, in accordance with an illustrative embodiment of the invention.

FIG. 9C illustrates a graph of Temperature (° C.) vs. Normalized Heat Flow (W/g) for a 100 nm membrane, 600 nm membrane, and a starting emulsion, in accordance with an illustrative embodiment of the invention.

FIGS. 10A-10B include diagrams showing distribution of water droplets on membranes used in accordance with an illustrative embodiment of the invention.

FIG. 11 shows SEM images of a 100% PSf membrane in accordance with an illustrative embodiment of the invention.

FIG. 12 shows SEM images of a 95% PSf, 5% PEG membrane in accordance with an illustrative embodiment of the invention.

FIG. 13 shows SEM images of a 90% PSf, 10% PEG membrane in accordance with an illustrative embodiment of the invention.

FIG. 14 illustrates an exemplary device 1400 that takes advantage of the electrowetting phenomenon. A voltage is supplied across an insulated electrode 1402 and the oil-water emulsion 1404 that in turn increases the hydrophilicity of the hydrophilic/oleophobic membrane 1406. In operation, water flows through the membrane and out of the sides.

FIG. 15 illustrates a device 1500 where the hydrophilic/oleophobic membranes 1502 are cascaded horizontally and the oleophilic/hydrophobic membranes 1504 are arranged vertically as shown in the setup on the left. When an oil-water emulsion passes through, water permeates through the device while oil is removed through the vertical oleophilic/hydrophobic membranes 1504 as shown on the right.

### DESCRIPTION

It is contemplated that articles, apparatus, methods, and processes of the claimed invention encompass variations and adaptations developed using information from the embodiments described herein. Adaptation and/or modification of the articles, apparatus, methods, and processes described herein may be performed by those of ordinary skill in the relevant art.

Throughout the description, where articles and apparatus are described as having, including, or comprising specific components, or where processes and methods are described as having, including, or comprising specific steps, it is contemplated that, additionally, there are articles and apparatus of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Embodiments of the invention provide methods and devices that use membranes to separate oil/water mixtures. The methods and devices have a wide range of applications, including deep seep oil exploration, oil purification, and oil spill cleanup.

### Methods in General

In one aspect, the invention provides a method for performing an oil/water separation, the method comprising: providing a first membrane that is hydrophilic and oleophobic; and contacting a first liquid stream or volume comprising oil and water with the first membrane, wherein the first membrane allows passage of water therethrough to produce a second liquid stream or volume.

In some embodiments, the method further includes providing a second membrane that is hydrophobic and oleophilic; and contacting the first liquid stream or volume comprising oil and water with the second membrane, wherein the second membrane allows passage of oil therethrough.

In some embodiments, the method further includes providing a second membrane that is hydrophobic and oleophilic; and contacting the second liquid stream or volume with the second membrane, wherein the second membrane allows passage of oil therethrough.

### Hydrophilic and Oleophobic First Membranes

In some embodiments, a first membrane that is hydrophilic and oleophobic is used.

In general, there are a wide variety of techniques that could be used to create a first hydrophilic/oleophobic membrane. One way is to employ surface bound surfactants. For example, in some embodiments the first membrane comprises cationic fluorosurfactants complexed to a polymer surface. In some embodiments, hydrophilic/oleophobic polymeric surfaces can be successfully fabricated using cationic fluorosurfactants complexed to a maleic anhydride plasma polymer surface (e.g., for methods of fabrication see Lampitt, R. A.; Crowther, J. M.; Badyal, J. P. S. J. Phys. Chem. B 2000, 104 (44) 10329-10331, which is incorporated herein by reference in its entirety). Cationic surfactants complexed to maleic anhydride plasma polymer layers readily undergo surface reconstruction in response to changes in their local liquid environment: repetitive alternation between oleophobic and hydrophilic behavior is observed. Fluorinated surfactants may be utilized to form self-assembled polyelectrolyte-fluorosurfactant complexes which display good oil and water repellency. This may be attributed to the packing and alignment of the low surface energy perfluorocarbon tails away from the underlying substrate. In some embodiments, the fluorinated surfactant undergoes direct complexation onto the surface of a plasma-deposited polyelectrolyte coating (e.g., a maleic anhydride plasma polymer surface). In some embodiments, the cationic fluorinated surfactant employed for complexation includes an ammonium ion headgroup separated by an alkyl spacer from the perfluorinated tail and a chloride counterion (R_{f}CH₂CH₂CH₂(CH₃)₃N⁺Cl⁻, where n=6-20 for the R_{f} chain). In one experiment, glass substrates coated with maleic anhydride plasma polymer were immersed in a dilute aqueous solution of the surfactant for 1 hour (at less than the critical micelle concentration for the surfactant), followed by rinsing with distilled water and drying in air. The resulting fluorosurfactant-plasma polymer layer was found to repel oil but allow the spreading of water—the measured contact angle with water was measured to be 22±2°, while the contact angle with hexadecane was measured to be 79±1°. In some embodiments, the ability to switch between oleophobicity and hydrophilicity could be repeated at least 20 times.

The liquid-specific response of the fluorosurfactant-plasma polymer system can be attributed to complexation occurring at the outer surface. Plasma-induced cross-linking during deposition prohibits penetration of the large surfactant moieties into the subsurface region. In turn this can be expected to suppress interdigitation, cooperative binding, and layering of the surfactant tails. An ultrathin array of aligned perfluorocarbon chains at the liquid-solid interface effectively repels nonpolar liquids, whereas polar molecules such as water either penetrate into the hydrophilic subsurface or cause the perfluorocarbon tails to reorganize in such a way as to vacate hydrophilic regions.

In some embodiments, cationic fluorosurfactants may be complexed to an acrylic acid plasma polymer surface (see Hutton, S. J.; Crowther, J. M.; Badyal, J. P. S. Chem. Mater. 2000, 12 (8) 2282-2286, which is incorporated herein by reference in its entirety). In some embodiments, ionic surfactants are coupled to pre-deposited polyelectrolyte plasma surfaces. Plasma polymerization is attractive because a wide range of substrate materials can be coated irrespective of their chemical nature, shape, or topography. Complexation of a cationic surfactant (e.g., a trialkylammonium ion headgroup separated by an ethylene spacer from the fluorinated tail) to an acrylic acid plasma polymer film can be carried out via any known methods. In one exemplary embodiment for manufacturing cationic fluorosurfactants complexed to an acrylic acid plasma polymer surface, glass slides were coated with acrylic acid plasma polymer (e.g., using any known method) and were then immediately immersed into a dilute solution of the cationic fluorosurfactant, and then rinsed several times in water, prior to being dried in air. The precise structure of the complexed surfaces is influenced by a number of factors, including relative volume fractions of ionic and alkyl phases present and the molecular geometry of the surfactant molecules.

Sessile drop contact angle measurements were carried out using a video capture apparatus (A.S.T. Products VCA2500XE). In some examples, high-purity water (hydrophobicity) and hexadecane (oleophobicity) were employed as the probe liquids. In some examples, the cationic fluorosurfactant—acrylic acid plasma polymer complex surface was found to switch between oleophobic and hydrophilic behavior. Indeed, for the cationic fluorosurfactant—acrylic acid plasma polymer complex surface, in one embodiment, the contact angle with water was measured to be <20° while the contact angle with hexadecane was measured to be 82±4°.

Complexation of ionic fluorosurfactants to polyelectrolyte plasma polymer surfaces gives rise to oleophobicity in combination with hydrophilicity. This “smart” behavior is reversible and attributable to surface reconstruction phenomena.

These surfaces described above (e.g., fluorosurfactant-plasma polymer surfaces and fluorosurfactant-acrylic acid plasma polymer surfaces) can be used to create membranes by additional processing or varying the way in which they are processed. In some embodiments, these hydrophilic/oleophobic membranes would allow water to pass through but not oil.

### Hydrophobic and Oleophilic Second Membranes and Manufacturing

In some of the aforementioned embodiments, a first hydrophilic/oleophobic membrane is combined with a second hydrophobic/oleophilic membrane to produce a more efficient method or device for separation of oil-water emulsions (or oil and water mixtures).

In general, there are a wide variety of techniques that may be used to create a second hydrophobic/oleophilic membrane. In some embodiments, the second membrane includes a polymer selected from the group consisting of polysulfone (PSF), poly(vinylpyrrolidone) (PVP), polyacrylonitrile (PAN), polycarbonate, polyethersulfone (PES), and/or any combination thereof.

In some embodiments, the second membrane is a hierarchical porous membrane, as described below. Thus, in some embodiments, the second membrane includes a first layer and a second layer, wherein the second layer is a support layer that is substantially thicker than the first layer and has a substantially larger average pore size than the first layer.

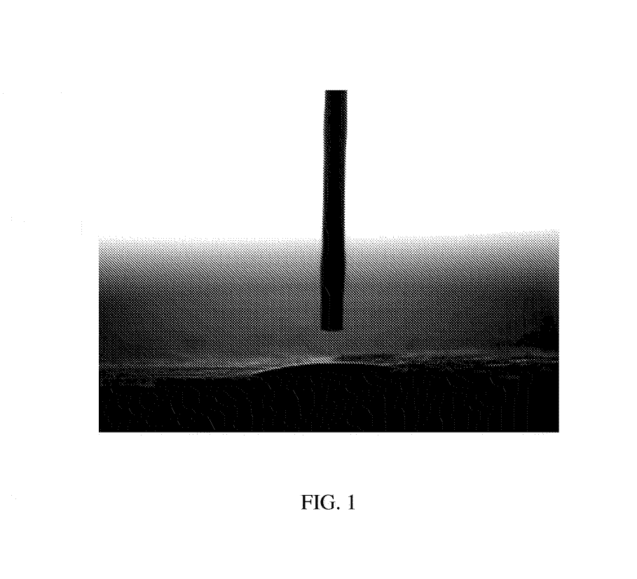

Referring now to FIG. 1, in certain embodiments, a second membrane is provided that is naturally oleophilic (e.g., it is spontaneously wetted by oil) and hydrophobic (e.g., it repels water droplets). This useful property allows oil to pass through the membrane and water to be blocked or stopped. In some embodiments, the ability of the membrane to separate oil and water is due at least in part to the membrane's structure. As shown in FIG. 1, oil wets the membrane to form a barely visible thin film.

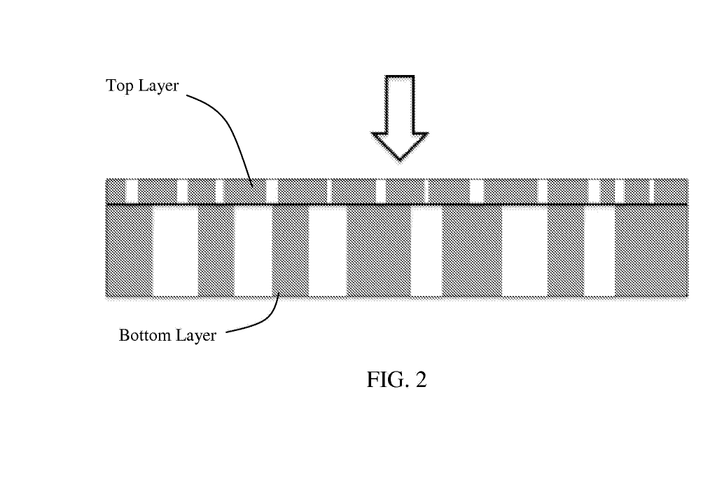

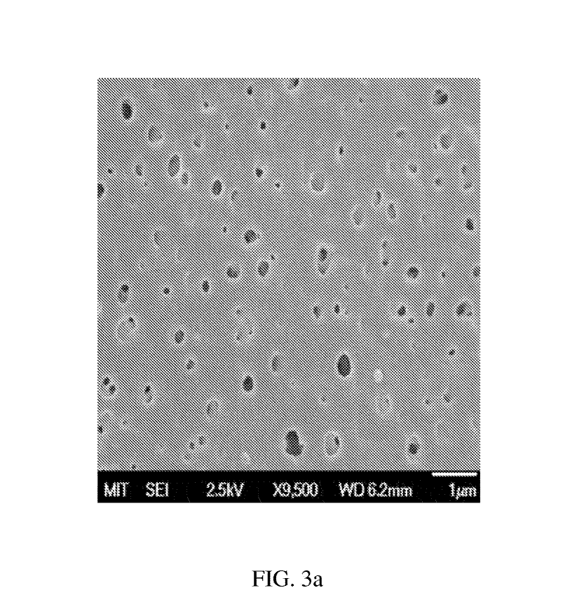

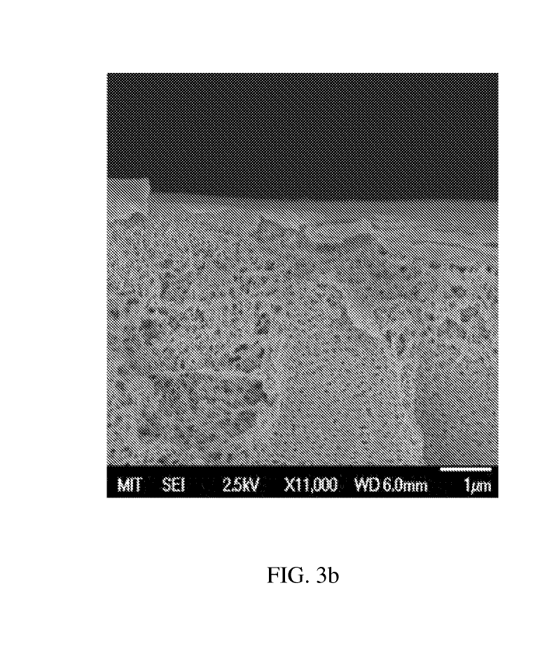

Referring now to FIGS. 2, 3A, and 3B, in certain embodiments, the membrane has a range from about 55 μm to 370 μm and includes a top layer and a bottom layer. The top layer has a thickness l₁ and includes a plurality of small pores having a diameter, in some embodiments, from about 25 nm to about 300 nm. The bottom layer has a thickness l₂ and includes a plurality of large pores having a diameter, in some embodiments, from about 10 μm to about 25 μm. As depicted in FIG. 2, the second membrane is designed for an emulsion to flow down through it, from the top layer to the bottom layer. The SEM images in FIGS. 3A and 3B show the nanoscale or small pores on a top surface of the top layer and the microscale or large pores immediately below the surface (in the bottom layer).

While not wishing to be bound by a particular theory, to understand how the second membrane operates, consider water in contact with the top surface of the membrane. The Young-Laplace equation states that the pressure difference p_{c} across the surface in question in given by Eq. 1 below:

p_{c}=(2γ cos θ)/r (1)

where γ is the, surface tension of water, θ is the contact angle for water, and r is the pore radius. For the hydrophobic membrane, θ for water is greater than 90° and, accordingly, there is a positive pressure difference p_{c} across the top surface that prevents the water from entering the pores. If this pressure difference is overcome, water may spontaneously enter the pores. In certain embodiments, the pressure necessary to force water to enter the pores of the membrane is referred to as the breakthrough pressure.

In various embodiments, the breakthrough pressure is controlled by varying the pore radius r. For example, a smaller pore radius r results in a higher breakthrough pressure. In addition, in some embodiments, the membrane is chemically treated to alter the contact angle for water θ. While the hydrophobic properties of the membrane prevent the passage of water, in various embodiments, the oleophilic properties of the membrane cause oil to wet the membrane and enter the pores of the membrane spontaneously. While again not wishing to be bound by a particular theory, Darcy's law is a phenomenologically derived equation that describes fluid flow through porous media:

Q=(−kA/μ)(Δp/L) (2)

In this equation, Q is the volumetric flowrate of the fluid, k is the permeability of the membrane, A is the surface area of the membrane, μ is the viscosity of the fluid, L is the thickness of the membrane, and Δp is the pressure difference across the membrane.

In certain embodiments, to maximize the flowrate of oil through the membrane, the permeability k and/or the pressure difference Δp are kept high, and/or the thickness L is kept low. To prevent the flow of water through the membrane, the pressure preferably does not exceed the breakthrough pressure.

In various embodiments, the membrane allows for the key parameters (e.g., breakthrough pressure and flowrate) to be systematically controlled. The methodology for controlling these parameters is summarized in Table 1 below.

TABLE 1
Key parameters for the second membrane:

| | | Positive | Negative |
|---|---|---|---|
| Property | Modify by | Effects On | Effects On |
| Decrease r | Controlling pore size | Breakthrough | Permeability, |
| | | pressure | flow rate |
| Increase θ | Chemical treatment | Breakthrough | |
| | | pressure | |
| Decrease l₁ | Membrane fabrication | Permeability | |
| Increase l₂ | Membrane fabrication | Stability | |

In some embodiments, membrane fabrication is bound by certain physical limits. For example, from a permeability standpoint, it would be preferable to make l₁ infinitely thin. In general, the easiest parameter of the membrane to influence or control is the pore radius r. Pore radius r, however, is coupled to both breakthrough pressure and permeability k. For example, in certain embodiments, the breakthrough pressure is inversely proportional to the radius r of the pores. At the same time, changing the radius r changes the permeability k. Fine-tuning the membrane may therefore be a delicate process.

Both breakthrough pressure and flowrate Q influence the separation efficiency of the membrane. In certain embodiments, the separation efficiency is defined as the flow of oil through the membrane divided by the total flow through the membrane. It is desirable to fine-tune the membrane to achieve the best flowrate possible.

In certain embodiments, a porous polysulfone (PSf) membrane is manufactured using a phase inversion process (e.g., immersion precipitation). The method uses the following ingredients: a polymer (e.g., polysulfone (PSf)) or polyacrylonitrile (PAN)); a solvent (e.g., organic, such as Dimethyl acetamide (DMAc) or n-methyl-2-pyrrolidone (NMP)); a non-solvent (e.g., DI water or a mixture of water/ethanol:90/10); and a pore former (e.g., poly(vinylpyrrolidone) (PVP) or Poly ethylene glycol (PEG) or a mixture of PVP/PEG (50/50)). The method includes dissolving the polymer in the solvent to produce a mixture, casting the mixture on a glass plate, and immersing the glass plate and mixture in a water bath to initiate phase inversion (also called immersion precipitation) to get the membrane films. During the phase inversion process, PVP and/or PEG creates macro pores. In general, a lower polymer concentration or addition of PEG creates bigger pores in the top layer.

In one embodiment, a porous polysulfone (PSf) membrane is prepared using a phase inversion technique based on a non-solvent induced phase separation method. A mixture of 7 g PSF and 3 g poly(vinylpyrrolidone) (PVP) is dissolved in 40 mL DMAc at 80° C. to form a homogeneous solution, which is then left at 50° C. for 12 hours to allow air bubbles to be released. Using a doctor blade knife or other cutting instrument, a thin layer (0.28 mm) of polymer solution is then casted on a glass plate which is then immersed into non-solvent water at room temperature (22° C.), to undergo coagulation. Phase separation of the polymer-solvent system takes place during this process, which creates an asymmetric microporous membrane matrix. To wash away the PVP additive completely, the porous membrane is then rinsed with running tap water for 24 hours, followed by immersion in a glycerol-water solution (volume ratio of 1:1) for another 24 hours, before being dried at ambient conditions.

In various embodiments, polyacrylonitrile (PAN) porous membranes are prepared in a similar fashion. Compared to PSf, PAN is generally less hydrophobic (contact angle with water is 71°, compared to 84° for PSf) and usually results in bigger pores on the surface.

In various embodiments, PVP and/or PEG are used as pore forming chemicals to create uniform arrays of macropores. Without PVP and/or PEG, the formation of macropores may be random, and the quality of the membrane microstructure may be poor.

In certain embodiments, the addition of a water and alcohol (e.g., ethanol) mixture in the bath makes the non-solvent less polar and can delay the mixing of solvent (DMAc) and the non-solvent (water and ethanol). In some embodiments, this creates a membrane where the top layer pore sizes are in the scale of 50 to 300 nm, due to delayed mixing.

In certain embodiments, the top layer of the membrane has a thickness l₁ from about 0.3 microns to about 1 micron (e.g., as determined from cross-sectional scanning electron microscopy of the membrane film). In some embodiments, the top layer (also referred to as the active layer) provides the separation efficiency or selectivity of the membrane. As mentioned above, the top layer includes the small pores (e.g., nanopores). In some embodiments, a pore diameter of the top layer is from about 25 nm to about 300 nm. The pore size may increase gradually from the top surface of the membrane to the inner structure.

In various embodiments, the bottom layer has a thickness l₂ from about 55 microns to about 370 microns (e.g., as determined from cross-sectional scanning electron microscopy of the membrane film). In some embodiments, the bottom layer provides mechanical support and gives negligible resistance to permeability, due to the large pores (e.g., macropores). In some embodiments, a pore diameter in the bottom layer is from about 10 microns to about 25 microns. The pore size may increase gradually toward the inner structure.

To form the top and bottom layers, in certain embodiments, the PSf polymer solution is cast as a film on a glass plate with a casting knife. The film is then immersed into a coagulation bath containing water. At the moment of immersion, DMAc diffuses out of the film, while water diffuses into the film. Because PSf is immiscible with the water, and has a relatively high molecular weight and a low diffusion coefficient, a relative velocity of the PSf molecules is very low. In some embodiments, diffusion therefore takes place in a polymer frame of reference. In some embodiments, as a result of instantaneous or near-instantaneous demixing, two phases result in the glass plate. In some embodiments, a first phase that is poor (lean) in polymer creates macropores for the bottom layer, and a phase that is rich in polymer creates nanopores for the top layer, for selective separation.

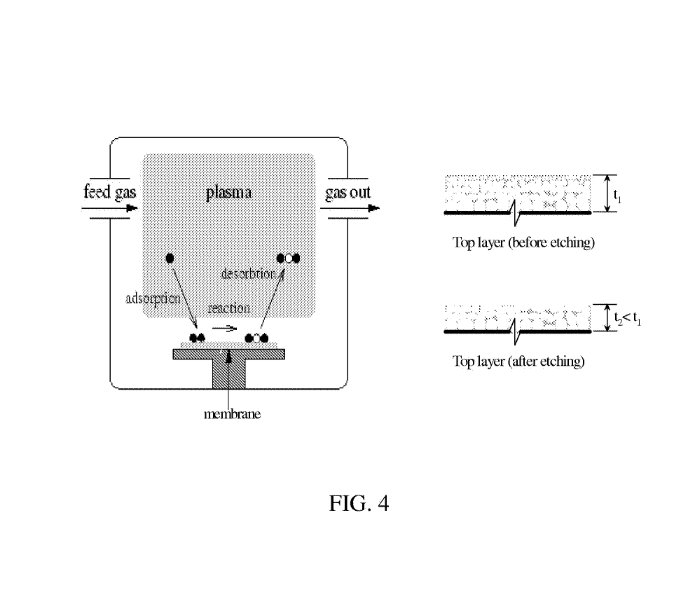

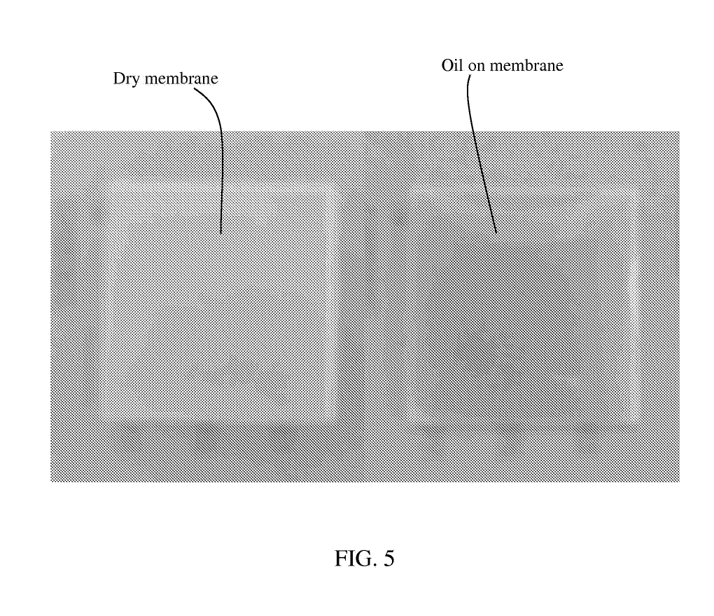

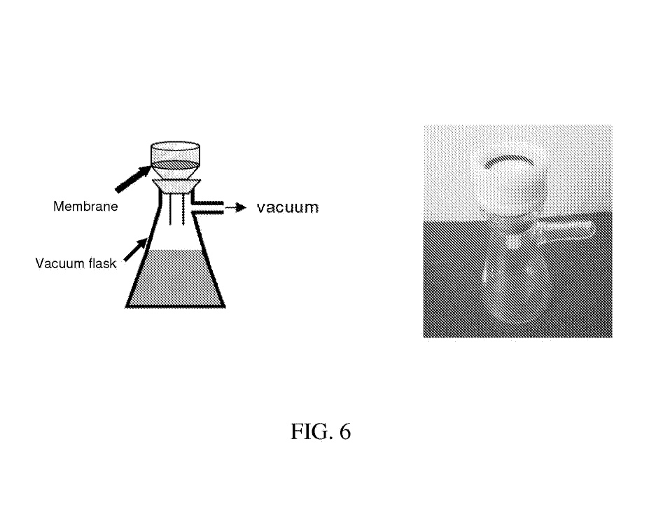

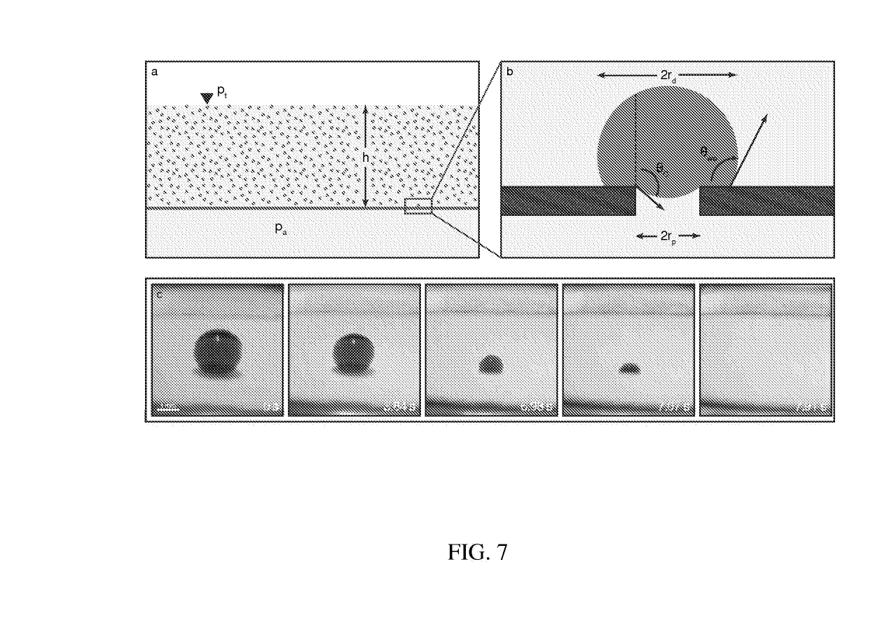

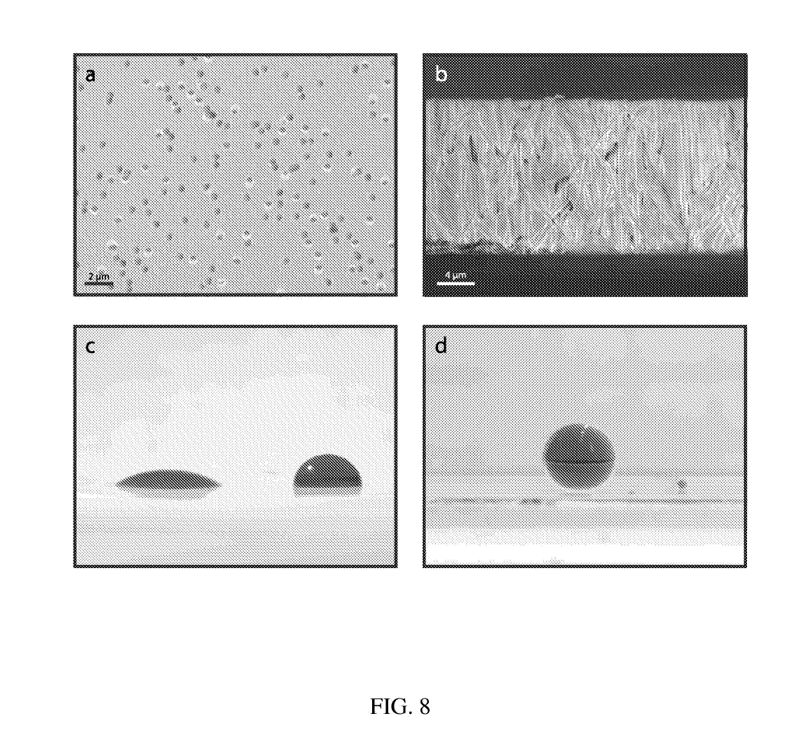

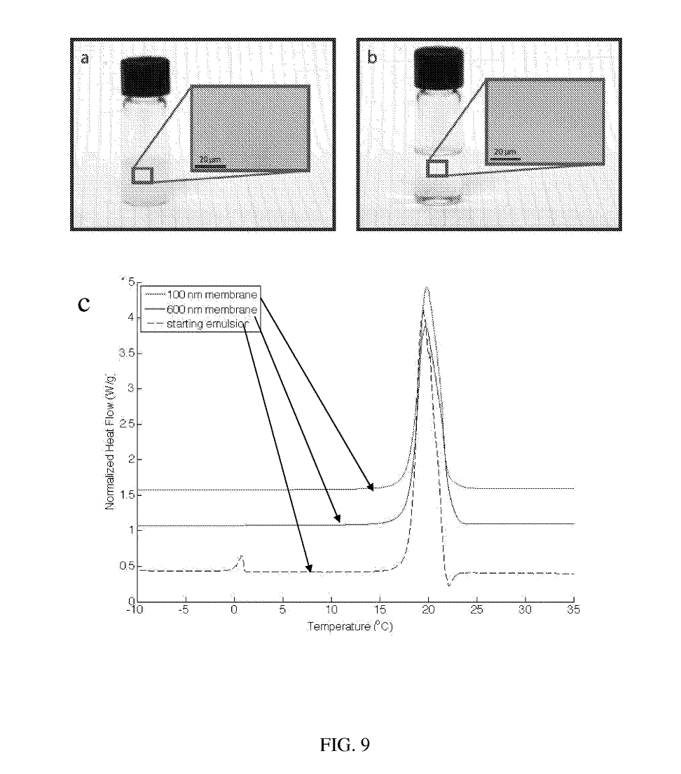

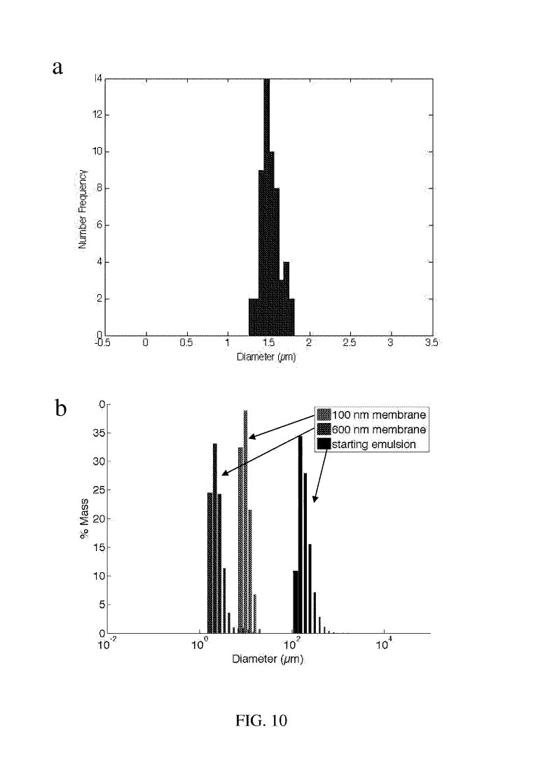

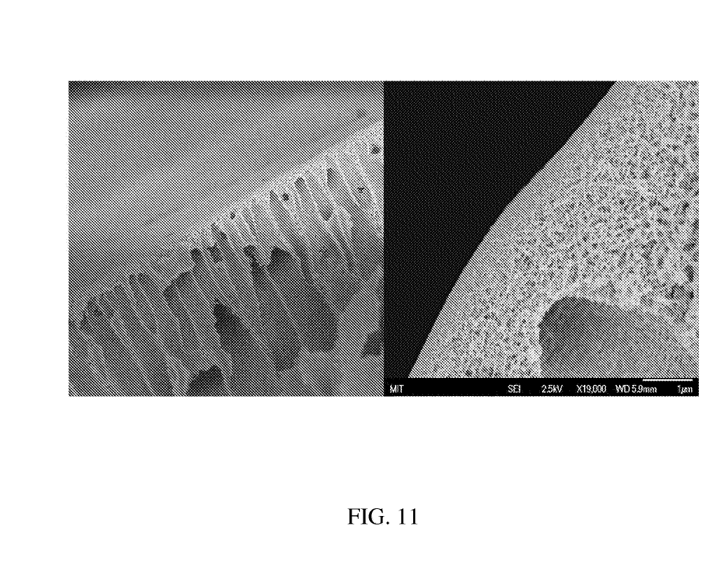

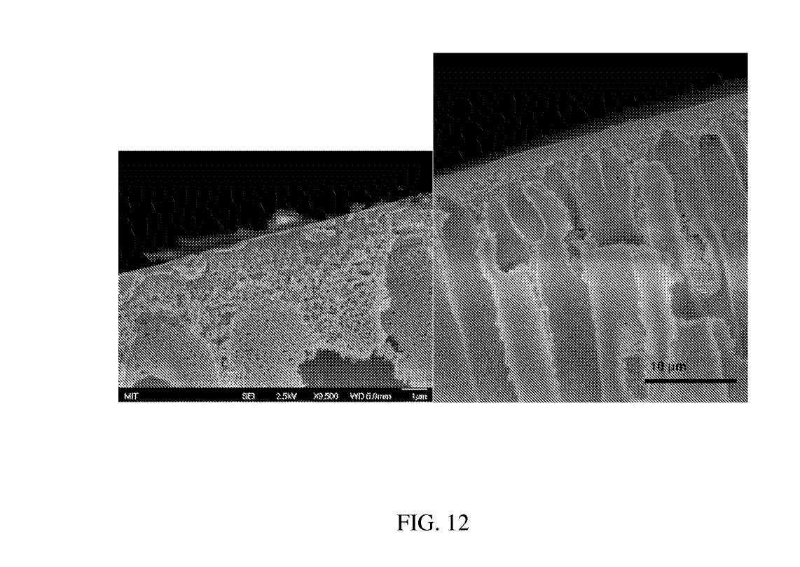

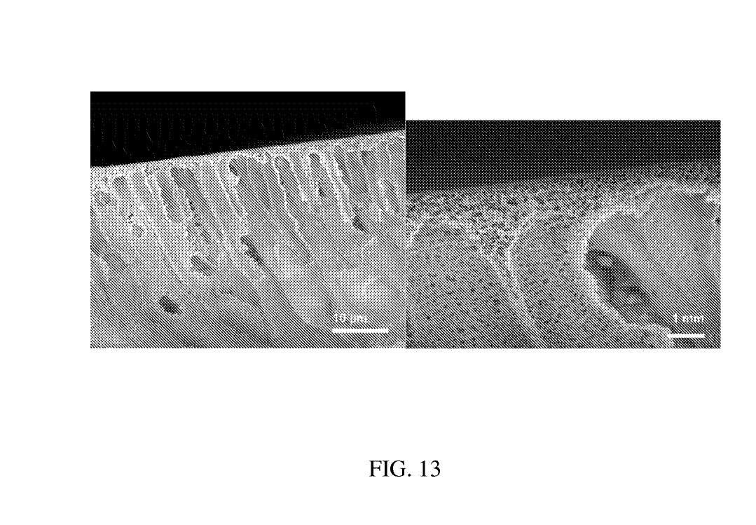

In certain embodiments, to improve the permeability of the PSf and/or PAN hierarchical membranes, selective or plasma etching of the top layer (e.g., where the pore sizes are 30-300 nm) is performed. The plasma etching is preferably performed, in some embodiments, in an O2 (oxygen) plasma chamber in a vacuum (200 mbar), for a controlled etching time of 3 to 10 seconds. FIG. 4 is a schematic of a plasma etching process, in accordance with certain embodiments of the invention. The plasma etching removes part of polymer material from the top layer surface, thereby decreasing an effective thickness of the top layer and opening up bigger pores (e.g., with size greater than 80 nm) beneath the original surface. The plasma etching process may be helpful to increase the overall permeability of the membrane.

In certain embodiments, the membranes and methods described herein are used to remove water from oil when the water concentrations are too low to be separated with conventional devices. For example, when the water concentration is higher than 0.5% by volume in the oil-water mixture, traditional separation devices (e.g., an ultracentrifuge) may be used. However, for trace amount of water (e.g., no greater than 3 wt % water content, no greater than 1 wt % water content, or 50-1000 ppm water), these traditional separation devices may be incapable of separating the water from the oil. Advantageously, for these trace amounts, the porous membranes (or combinations of the porous membranes) described herein may be used to perform the separation. In some embodiments, these membranes have a have high affinity for oil (e.g., contact angle less than 10°) and a low affinity for water (e.g., contact angle of about 84°). In various embodiments, PSf is the polymer used to form the porous structure suitable for the separation of low concentrations (e.g., on the order of ppm) of water from oil.

The membranes and methods have several applications in the petroleum industry. For example, the membranes and methods may be used to remove trace amounts of water from oil to obtain higher oil concentrations and improve the performance of machines that use the oil (e.g., combustion engines). In addition, the membranes and methods discussed herein may be used to remove trace amounts of oil from water contaminated with oil, for example, before releasing the water into the environment or before otherwise reusing the water. In some embodiments, the amount of oil in the water after the separation process is 10 ppm of oil or less.

In some embodiments, the membranes and methods discussed herein may be used to separate oil from the bilge water accumulated in ships, as required by the international MARPOL Convention.

Without wishing to be limited to any particular theory, the smaller pores on the top layer of the second membrane are thought to block water from passing through. The smaller the pores, the greater a pressure can be applied before water begins to pass through the membrane. The thicker support layer with larger pores provides stability while not contributing much additional resistance to the flow.

In some embodiments, the first layer of the second membrane has a thickness from about 0.3 micron to about 2 microns, e.g., from about 0.5 micron to about 2 microns. In some embodiments, the first layer of the second membrane has an average pore size from about 25 nm to about 300 nm, e.g., from about 50 nm to about 200 nm or from about 100 nm to about 150 nm.

In some embodiments, the support layer of the second membrane has a thickness from about 55 microns to about 370 microns. In some embodiments, the support layer of the second membrane has an average pore size from about 10 microns to about 25 microns. In some embodiments, the second membrane is an open-cell structure. In some embodiments, each layer of the second membrane includes interconnected pores.

In some embodiments, the first layer of the second membrane comprises a coating, e.g., a silane coating. In some embodiments, the silane coating comprises at least one member selected from the group consisting of octadecyltrichlorosilane (OTS), methylsilane, phenylsilane, isobutylsilane, dimethylsilane, tetramethyldisilane, hexylsilane, octadecylsilane, and fluorosilane.

In some embodiments, the second membrane comprises polycarbonate and a coating comprising octadecyltrichlorosilane (OTS).

### Switchable Wetting

In some embodiments, the invention provides a method for performing an oil/water separation, the method comprising: providing a membrane that is either hydrophilic and oleophobic or hydrophobic and oleophilic depending on a polarity of a contacting medium; passing a first liquid stream or volume comprising oil and water, and having a first water to oil ratio, wherein the first ratio is greater than 1; contacting the first liquid stream or volume with the membrane, wherein the membrane is hydrophilic and oleophobic during contact with the first stream or volume and allows passage of water therethrough; and contacting a second liquid stream or volume with the membrane, wherein the second liquid stream or volume has a second water to oil ratio less than 1, and wherein the membrane is hydrophobic and oleophilic during contact with the second stream or volume, and does not allow passage of water therethrough.

In some embodiments, the first stream or volume is an initial condition of the stream or volume and the second stream or volume is a following condition of the same stream or volume. For example, the composition of a stream or volume comprising oil and water will change over time as oil (or water) is removed from the stream or volume. In this situation, this may lead to a change in the polarity of the stream or volume which would in turn affect whether the membrane it is contacting is hydrophilic and oleophobic or hydrophobic and oleophilic.

In some embodiments, the membrane is such that it will let water pass through if in contact with an oil-water emulsion that is mostly water but will not let water pass through if the oil-water emulsion is mostly oil.

In some embodiments, the membrane comprises a polymer. In some embodiments, the polymer is a polyurethane, e.g., a polyurethane that comprises a perfluoropolyether (PFPE) segment, a polydimethylsiloxane (PDMS) segment, a polyethylene glycol (PEG) segment, and/or any combination thereof (e.g., see Vaidya, A.; Chaudhury, M. K. J. Colloid Interface Sci. 2002, 249 (1) 235-245 the entire contents of which are incorporated herein by reference).

### Electrowetting

The basis for electrowetting was first described by Gabriel Lippmann in 1875 (see Lippmann G., “Relations entre les phenomenes electriques et capillaires” Ann. Chim. Phys. 1875, 5 494). Consider a water droplet on a surface. If a voltage is applied between the water drop and an insulated surface the fringing field at the corners of the drop will tend to pull the droplet down onto the electrode and lower the contact angle (see Chang, H. C., Yeo, L. (2009). Electrokinetically Driven Microfluidics and Nanofluidics. Cambridge University Press). Thus, the wetting properties of a surface may be modified with application of electric fields. As a result, a surface can be made more hydrophilic by applying a voltage between it and the water in contact with it.

Because electrowetting has the potential to make a surface (and thus a membrane) more hydrophilic, it also has the potential to increase the separation efficiency of a hydrophilic membrane. In addition, it also presents the possibility to fine-tune the performance of the membrane by altering the voltage. The separation efficiency of a membrane can thus be fine-tuned to match characteristics of the emulsion flowing through. Because changing the current can spontaneously change the voltage of an electrowetting membrane, the membrane can be very quickly adjusted to maximize performance based on the exact concentrations of oil and water in the emulsion it is separating. Electrowetting can be applied to any system in which a polar liquid is present. In an oil-water emulsion oil is not affected because it is not polarizable.

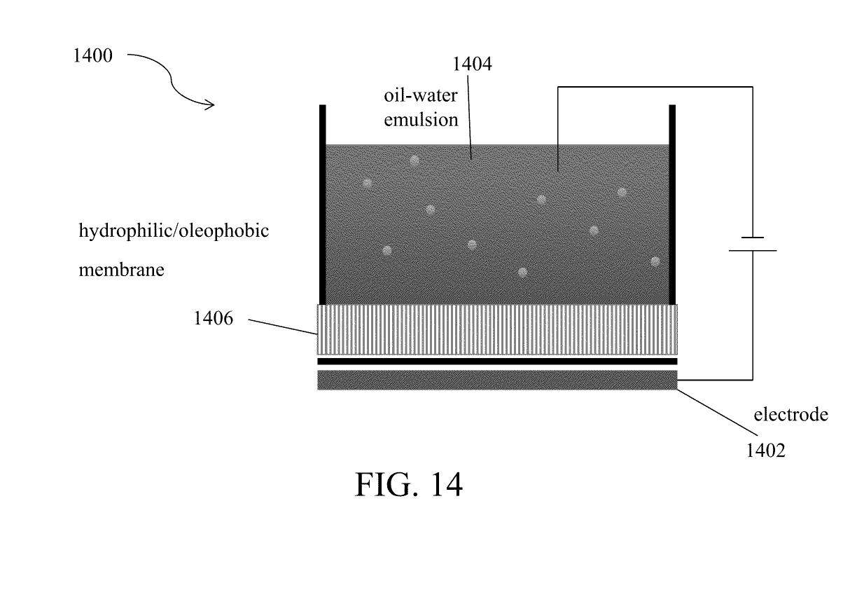

FIG. 14 shows an exemplary device 1400 that takes advantage of the electrowetting phenomenon. In operation, water flows through the hydrophilic/oleophobic membrane 1406 and out the sides. A voltage is supplied across an insulated electrode 1402 and the oil-water emulsion 1404 that in turn increases the hydrophilicity of the membrane.

### Applications

As noted previously, the leading methods for separating oil and water are either environmentally unfriendly or extremely energy intensive. For example, in oil extraction the leading method is to pump oil emulsified in water to the surface and store it in gravity separation tanks. Pumping the complete emulsion to the surface requires substantially more power than pumping the oil alone.

Using the methods and devices of the invention separation of an oil-water emulsion at the seafloor is feasible. Once separated, the oil can be pumped to the surface for further purification. While it is possible to accomplish subsea separation with conventional methods, those methods are not practicable—for example, because the hardware required for this is too large to reliably operate far underwater.

In some embodiments, the methods and devices are used in an oil well. The oil well could be offshore or on land. In some embodiments, the methods and devices are used in a deep oil well, e.g., at least 0.5 km, at least 1 km, at least 2 km or at least 3 km below the surface. In some embodiments, the methods and devices are used to separate oil from an oil-water emulsion below the surface and the extracted oil is then pumped to the surface.

In addition to removing water from oil-rich emulsions, a major problem in the petroleum industry is removing oil from water-rich emulsions. The Environmental Protection Agency (EPA) mandates a minimum oil content for discharged water. This number generally falls around 35 mg/L but varies based on where the water is discharged. The methods and devices of the invention can be used to separate oil from water-rich emulsions and provide a lower cost alternative to current purification techniques.

In certain embodiments, the methods and devices described herein are used to remove water from oil when the water concentrations are too low to be separated with conventional devices. For example, when the water concentration is higher than 0.5% by volume in the oil-water mixture, traditional separation devices (e.g., an ultracentrifuge) may be used. However, for trace amount of water (e.g., no greater than 3 wt % water content, no greater than 1 wt % water content, or 50-1000 ppm water), these traditional separation devices may be incapable of separating the water from the oil. Advantageously, for these trace amounts, the hierarchical porous membranes described herein may be used to perform the separation.

### EXAMPLES

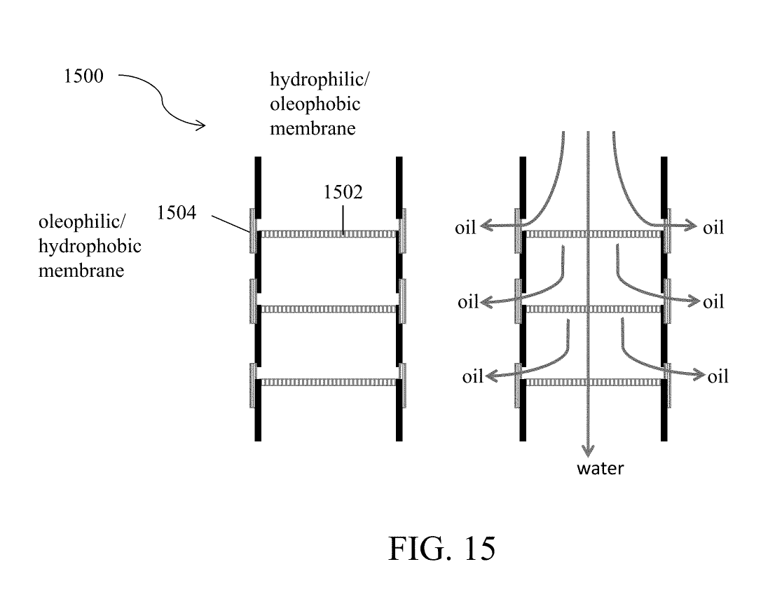

FIG. 15 shows one exemplary configuration of a device of the invention that could be used to separate an oil-water emulsion. The device includes a horizontal hydrophilic/oleophobic first membranes arranged in series across the width of the channel and oleophilic/hydrophobic second membranes arranged vertically within holes in the walls of the channel.

The first level includes a large pore membrane to efficiently separate the water and oil. At maximum efficiency a membrane will not remove all oil from the water, but the largest oil droplets will be removed. The next membrane has smaller pores and filters more of the oil out. Such a configuration is far more efficient that a single membrane.

As shown in FIG. 15, the device 1500 allows water to pass through and removes oil from the sides. A similar device that allows oil to pass through and removes water out from the side can also be constructed by switching the configuration of the first and second membranes.

Electrowetting could also be incorporated to each of the hydrophilic/oleophobic first membranes to increase their performance. In its current form, the performance of the device would be specifically suited to a specific emulsion. If electrowetting is incorporated, the membranes can be actively tuned based on whatever emulsion is flowing through the device.

### OTHER EMBODIMENTS

Embodiments and examples described herein are for illustration purpose only not for limitation. The scope of the invention is illustrated by the claims attached and appendixes hereto and various changes and modifications within the scope of the invention will be apparent to those skilled in the art.

1. A method for performing an oil/water separation, the method comprising:
providing a membrane that is either hydrophilic and oleophobic or hydrophobic and oleophilic depending on a polarity of a contacting medium;
passing a first liquid stream or volume comprising oil and water, and having a first water to oil ratio, wherein the first ratio is greater than 1;
contacting the first liquid stream or volume with the membrane, wherein the membrane is hydrophilic and oleophobic during contact with the first stream or volume and allows passage of water therethrough; and
contacting a second liquid stream or volume with the membrane, wherein the second liquid stream or volume has a second water to oil ratio less than 1, and wherein the membrane is hydrophobic and oleophilic during contact with the second stream or volume, and does not allow passage of water therethrough.

2. The method of claim 1, wherein the first stream or volume is an initial condition of the stream or volume and the second stream or volume is a following condition of the same stream or volume.

3. The method of claim 1, wherein the membrane comprises a polymer.

4. The method of claim 3, wherein the polymer is a polyurethane.

5. The method of claim 4, wherein the polyurethane comprises a perfluoropolyether (PFPE) segment, a polydimethylsiloxane (PDMS) segment, a polyethylene glycol (PEG) segment, or any combination thereof.

6. A method for performing an oil/water separation, the method comprising:
providing a first membrane that is hydrophilic and oleophobic;
contacting a first liquid stream or volume comprising oil and water with the first membrane, wherein the first membrane allows passage of water therethrough to produce a second liquid stream or volume; and
applying a voltage between a portion of the first membrane and the first liquid stream thereby enhancing the hydrophilicity of the portion of the first membrane.

7. The method of claim 6 further comprising:
providing a second membrane that is hydrophobic and oleophilic; and
contacting the first liquid stream or volume comprising oil and water with the second membrane, wherein the second membrane allows passage of oil therethrough.

8. The method of claim 6 further comprising:
providing a second membrane that is hydrophobic and oleophilic; and
contacting the second liquid stream or volume with the second membrane, wherein the second membrane allows passage of oil therethrough.

9. A method for performing an oil/water separation, the method comprising:
providing a second membrane that is hydrophobic and oleophilic;
contacting a first liquid stream or volume comprising oil and water with the first membrane, wherein the second membrane allows passage of oil therethrough to produce a second liquid stream or volume;
applying a voltage between a portion of the first membrane and the first liquid stream thereby enhancing the hydrophilicity of the portion of the first membrane;
providing a first membrane that is hydrophilic and oleophobic; and
contacting the second liquid stream or volume with the second membrane, wherein the first membrane allows passage of water therethrough.

10. The method of claim 7, wherein the second membrane comprises a polymer selected from the group consisting of polysulfone (PSF), poly(vinylpyrrolidone) (PVP), polyacrylonitrile (PAN), polycarbonate, polyethersulfone (PES), and any combination thereof.

11. The method of claim 7, wherein the second membrane comprises a first layer and a second layer, wherein the second layer is a support layer that is substantially thicker than the first layer and has a substantially larger average pore size than the first layer.

12. The method of claim 11, wherein the first layer has a thickness from about 0.3 micron to about 2 microns.

13. The method of claim 11, wherein the first layer has an average pore size from about 25 nm to about 300 nm.

14. The method of claim 11, wherein the support layer has a thickness from about 55 microns to about 370 microns.

15. The method of claim 11, wherein the support layer has an average pore size from about 10 microns to about 25 microns.

16. The method of claim 11, wherein the first layer comprises a coating.

17. The method of claim 16, wherein the coating is a silane coating.

18. The method of claim 17, wherein the silane coating comprises at least one member selected from the group consisting of octadecyltrichlorosilane (OTS), methylsilane, phenylsilane, isobutylsilane, dimethylsilane, tetramethyldisilane, hexylsilane, octadecylsilane, and fluorosilane.

19. The method of claim 11, wherein the second membrane comprises polycarbonate and wherein the second membrane has a coating comprising octadecyltrichlorosilane (OTS).

20. A device for performing an oil/water separation, the device comprising a channel, wherein the channel comprises a first opening with a first membrane that is hydrophilic and oleophobic and a second opening with a second membrane that is hydrophobic and oleophilic, wherein the first and second membranes are configured so that when a liquid stream or volume comprising oil and water is introduced into the channel it contacts the first and second membranes, wherein the first membrane allows passage of water therethrough and the second membrane allows passage of oil therethrough.

21. The device of claim 20, wherein the first membrane is configured across the width of the channel and the second membrane is configured across an opening in a wall of the channel.

22. The device of claim 20, wherein the second membrane is configured across the width of the channel and the first membrane is configured across an opening in a wall of the channel.

23. The device of claim 20, wherein the device comprises a plurality of first membranes that are configured across the width of the channel.

24. The device of claim 23, wherein the plurality of first membranes includes at least two first membranes with different average pore sizes.

25. The device of claim 24, wherein the average pore size of the plurality of first membranes gets progressively smaller as one travels downstream along the channel.

26. The device of claim 23, wherein the plurality of first membranes are spaced apart and each separated by one or more openings in a wall of the channel.

27. The device of claim 26, wherein a plurality of second membranes are configured across the one or more openings in the wall of the channel.

28. The device of claim 27, wherein the plurality of second membranes includes at least two second membranes with different average pore sizes.

29. The device of claim 28, wherein the average pore size of the plurality of second membranes gets progressively smaller as one travels downstream along the channel.

30. The device of claim 20, wherein the device comprises a plurality of second membranes that are configured across the width of the channel.

31. The device of claim 30, wherein the plurality of second membranes includes at least two second membranes with different average pore sizes.

32. The device of claim 31, wherein the average pore size of the plurality of second membranes gets progressively smaller as one travels downstream along the channel.

33. The device of claim 30, wherein the plurality of second membranes are spaced apart and each separated by one or more openings in a wall of the channel.

34. The device of claim 33, wherein a plurality of first membranes are configured across the one or more openings in the wall of the channel.

35. The device of claim 34, wherein the plurality of first membranes includes at least two first membranes with different average pore sizes.

36. The device of claim 35, wherein the average pore size of the plurality of first membranes gets progressively smaller as one travels downstream along the channel.

37. The device of claim 20, wherein the first membrane comprises cationic fluorosurfactants complexed to a polymer surface.

38. The device of claim 37, wherein the first membrane comprises cationic fluorosurfactants complexed to a maleic anhydride plasma polymer surface.

39. The device of claim 37, wherein the first membrane comprises cationic fluorosurfactants complexed to an acrylic acid plasma polymer surface.

40. The device of claim 20, further comprising one or more electrical elements configured to apply a voltage between a portion of the first membrane and a liquid stream in the channel, thereby enhancing the hydrophilicity of the portion of the first membrane.

41. The device of claim 20, wherein the second membrane comprises a polymer selected from the group consisting of polysulfone (PSF), poly(vinylpyrrolidone) (PVP), polyacrylonitrile (PAN), polycarbonate, polyethersulfone (PES), and any combination thereof.

42. The device of claim 20, wherein the second membrane comprises a first layer and a second layer, wherein the second layer is a support layer that is substantially thicker than the first layer and has a substantially larger average pore size than the first layer.

43-44. (canceled)

45. The device of claim 44, wherein the first layer has an average pore size from about 50 nm to about 200 nm.

46-50. (canceled)

51. A method for performing an oil/water separation, the method comprising:
providing a first membrane that is hydrophilic and oleophobic; and
contacting a first liquid stream or volume comprising oil and water with the first membrane, wherein the first membrane allows passage of water therethrough to produce a second liquid stream or volume.

52. The method of claim 51 further comprising:
providing a second membrane that is hydrophobic and oleophilic; and
contacting the first liquid stream or volume comprising oil and water with the second membrane, wherein the second membrane allows passage of oil therethrough.

53. The method of claim 51 further comprising:
providing a second membrane that is hydrophobic and oleophilic; and
contacting the second liquid stream or volume with the second membrane, wherein the second membrane allows passage of oil therethrough.

54. A method for performing an oil/water separation, the method comprising:
providing a second membrane that is hydrophobic and oleophilic;
contacting a first liquid stream or volume comprising oil and water with a first membrane, wherein the second membrane allows passage of oil therethrough to produce a second liquid stream or volume;
providing the first membrane that is hydrophilic and oleophobic; and
contacting the second liquid stream or volume with the second membrane, wherein the first membrane allows passage of water therethrough.

55-66. (canceled)
